(19) United States
(12) Patent Application Publication
(10) Pub. No.: US 2013/0332587 A1
(43) Pub. Date: Dec. 12, 2013

(54) Method and a system for on-boarding, administration and communication between cloud providers and tenants in a share-all multi-tenancy environment

(71) Applicants: Barnea Maya, Kiriat Bialik (IL); Greggo-McManus Andrea L., Gardiner, NY (US); Landau Ariel, Nesher (IL); Sweenor David E., Morrisville, NC (US); Wrzesien Michael Melvin, Raleigh, NC (US); Yaeli Avi, Ramot Menashe (IL); Yarter Lawrence C., Clinton Corners, NY (US)

(72) Inventors: Barnea Maya, Kiriat Bialik (IL); Greggo-McManus Andrea L., Gardiner, NY (US); Landau Ariel, Nesher (IL); Sweenor David E., Morrisville, NC (US); Wrzesien Michael Melvin, Raleigh, NC (US); Yaeli Avi, Ramot Menashe (IL); Yarter Lawrence C., Clinton Corners, NY (US)

(73) Assignee: INTERNATIONAL BUSINESS MACHINES CORPORATION, Armonk, NY (US)

(21) Appl. No.: 13/492,935

(22) Filed: Jun. 11, 2012

(51) Int. Cl. G06F 15/173

(52) U.S. Cl. 709/223

(57) ABSTRACT

A method of ascertaining requirements for onboarding new users to a multi-tenant computing environment is provided herein. The method starts off with the stage of recognizing the organizational roles of the new users. The method continues to the stage of identifying parameters pertaining to the service. The method then goes on to mapping the organization roles of the new users and the service parameters to a set of rules. The method further includes determining actions needed to be taken on the computer environment based on the set of rules. Finally, the method goes on to the stage of onboarding the new users to the computer environment.

### BACKGROUND

1. Technical Field

The present invention relates to management of computer resources network and more particularly, to optimization of the performance and service levels of the computer resources network in order to accommodate requests for onboarding new users in a multi-tenant environment.

2. Background of the Invention

In recent years, computer resources network, or Cloud computing, has become a real alternative to traditional computing, by providing a large variety of computing resources, all accessible to users via the Web. In order to reduce cost and improve economies of scale, some Cloud computing services are offered on a multi-tenant basis, in which the same computing environment is shared by multiple tenants, each utilizing the computing resources for their respective needs.

One or more service providers of Cloud computing services regularly need to onboard one or more new users and allow them access to Cloud computing services. The service providers typically have to identify the new users and grant them access to Cloud computing services based on their organizational role.

Currently available technologies enable service providers of Cloud computing services to manage access of new users to the Cloud computing environment. These technologies automate the authentication of the users and provisioning of the Cloud computing services.

### BRIEF SUMMARY

Regularly, service providers of Cloud computing have contractual obligations to their tenants, based on service level agreements (SLA), in which desired service parameters pertaining to the usage of Cloud resources are articulated.

In order to overcome the complexity of managing the infrastructure of multi-tenant Cloud computing environment, service providers of Cloud computing services need to consider the organizational roles of the users and the service parameters and the capabilities and limitations of the Cloud computing environment itself. This is particularly important when onboarding users to a multi-tenant shared Cloud computing environment, in which the computing needs of one user from one tenant can be significantly different from the computing needs of another user from the same or different tenant, and as a result may impact the service level of other users and/or tenant. Furthermore, in an enterprise context, additional considerations need to be taken into account, such as addressing the user computing needs and meeting the organizational mandates which may differ from one tenant to another.

Existing solutions to managing the infrastructure and architecture of multi-tenant Cloud computing environment, to ensure adequate service level is provided to the tenants, are usually reactive in nature. Once service level deteriorates below a certain level the service providers of the Cloud computing environment determine and execute actions pertaining to the infrastructure and architecture of the Cloud computing environment in order to improve the service parameters back to a desired level. A non-limiting example of such actions is the increase in memory storage space. Given the diversity in usage patterns of different tenants and different user groups within each tenant for each service, it is a very complex task, in a multi-tenant shared Cloud computing environment, to predict and ascertain beforehand the impact of adding a new user to the Cloud computing environment on the service level.

One aspect of the present invention provides a method of ascertaining requirements for onboarding new users to a multi-tenant Cloud computer environment. This method includes recognizing the organizational roles of new users. The method further includes identifying parameters pertaining to the service. The method further includes modeling the organization roles of the new users and the service parameters to a model associated with a set of rules. The method further includes determining actions needed to be taken on the computer environment based on the model and the set of rules. The method further includes onboarding the new users to the computer environment.

Other aspects of the invention may include a system for ascertaining the requirements for onboarding new users to a multi-tenant Cloud computing environment. The system includes a role recognizer configured to recognize organizational roles of new users. The system further includes a service identifier configured to identify service parameters. The system further includes a modeler configured to map the organization roles of the new users and the service parameters to a set of rules. The system further includes an actions determiner configured to determining actions needed to be taken on the computer environment based on the set of rules. The system further includes an onboarding unit configured to onboard the new users to the computer environment.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A is a high level schematic block diagram illustrating an exemplary system according to some embodiments of the invention;

FIG. 1B is a diagram illustrating an exemplary aspect according to some embodiments of the invention; and

FIG. 2 is a high level flowchart diagram illustrating a method according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “computer resources network” sometimes referred to in the computing industry as “cloud” or “cloud computing” is used in the context of this application to a network of computers that includes a variety of distributed computer resources which are accessible to a plurality of users usually via secured communication links. The resources may include anything from processing resources such as central processing units (CPUs) to volatile memory such as Random Access Memory (RAM) and non-volatile memory such as magnetic hard disks and the like. Additionally, the resources may also include software accessed and delivered according to the software as a service (SaaS) paradigm.

The term “tenant” as used herein in this application refers to a customer organization and/or end users using the services of the Cloud computing environment. The term “multi-tenant” describes multiple customer organizations and/or end users using the same Cloud computing environment.

The term “onboarding” as used herein in this application refers to the mechanism of handling new users, granting them access to computing services, carrying out provisioning, and configuring the right environment, based on their organizational roles.

The term “provisioning” as used herein in this application refers to all the steps required to manage (setup, amend, and revoke) user or system access entitlements or data relative to electronically published services.

The term “instance” as used herein in this application refers to a single copy of a computer environment. Multiple instances of a computer environment that the program has been loaded into memory several times. Non-limiting examples of instances are Development Environment, Testing Environment, and Production Environment.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

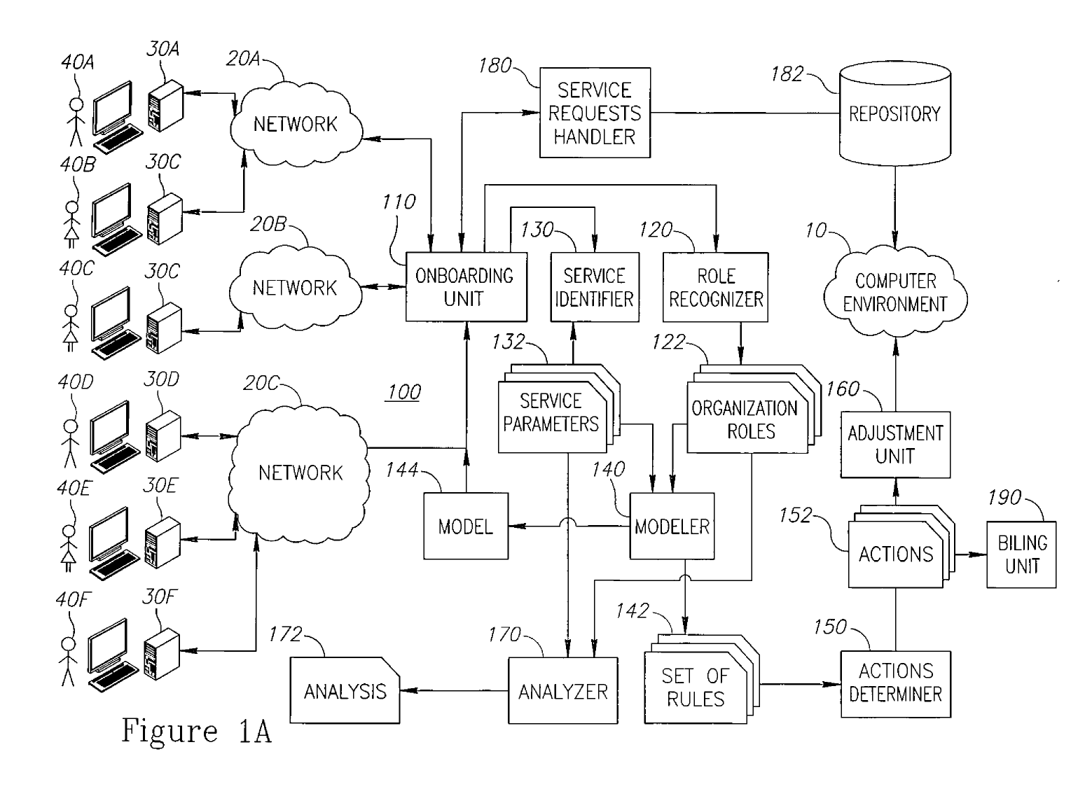

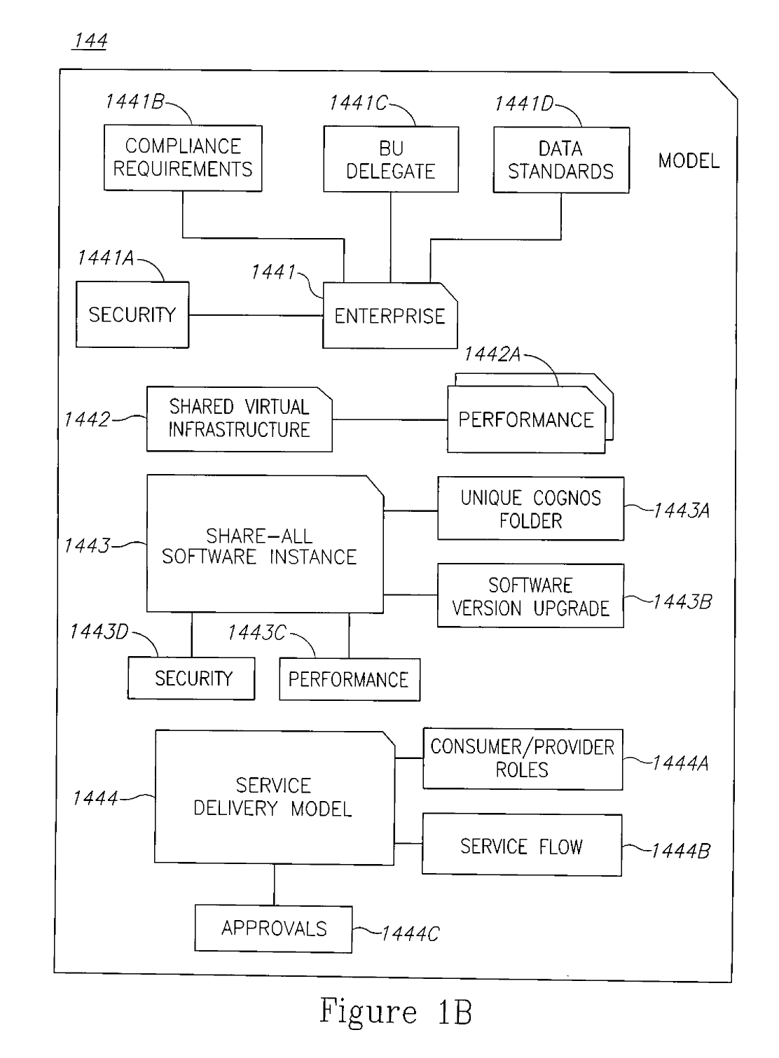

FIG. 1A is a high level schematic block diagram illustrating an environment in which a non-limiting exemplary system 100 may be implemented in a client-server configuration according to some embodiments of the present invention. Several users 40A-40F are connected via respective client computers 30A-30F to two or more different computer networks 20A-20C such that each one of computer networks 20A-20C represents a different organization or company.

On the server side, several elements implement system 100 for ascertaining requirements for onboarding new users in a computer environment having a plurality of services and a plurality of users from a plurality of organizations. System 100 includes a role recognizer 120 configured to recognize organizational roles 122 of new users. System 100 further includes a service identifier 130 configured to identify service parameters 132 (which may include enterprise requirements). System 100 further includes a modeler 140 configured to map the organization roles of the new users and the service parameters 132 to a model 144 and a set of rules 142. System 100 further includes actions determiner 150 configured to determine actions needed to be taken on the computer environment based on model 144 and the set of rules 142. System 100 further includes an onboarding unit 110 configured to onboard the new users to the computer environment 10 in accordance with model 144.

Consistent with some embodiments of the present invention, system 100 further includes an adjustment unit 160 configured to adjust the computer environment based on the determined actions.

Consistent with some embodiments of the present invention, system 100 further includes an analyzer 170 configured to analyze the impact of the onboarding new users on other organizations using services on the computer environment, based on the organizational role of new users and the identified service parameters, and provide and analysis 172.

Consistent with some embodiments of the present invention, at least some of the new users have different roles in different instances of the computer environment.

Consistent with some embodiments of the present invention, system 100 further includes a service requests handler 180 configured to maintain service requests for adding the new users in a central repository 182.

Consistent with some embodiments of the present invention, system 100 further includes comprising a communication unit configured to communicate computer environment information to users, based on recognized organizational roles.

Consistent with some embodiments of the present invention, system 100 further includes a billing unit 190 configured to bill users based on the actions 152 needed to be taken on the computer environment.

FIG. 1B is a diagram illustrating an exemplary model 144 according to some embodiments of the present invention. By way of example, and not by way of limiting, exemplary model 144 is based on delivering an IBM® software product called Cognos® Business Intelligence (BI) as a service. It is noted that a model may be generated for any type of software product delivered as a service and is not limited to a single type of product. The model comprises a multi dimensional representation of the parameters that are indicative of any data that may be relevant to the onboarding process. Each dimension of model 144 is a business aspect or a different professional perspective of the SaaS environment.

For example model 144 may include Enterprise 1441 parameters such as compliance requirements 1441A, BU delegate 1441B, data standards 1441C, and security 1441D. Another set of parameters that may be included in model 144 relate to shared virtual Infrastructure 1442 for example, performance 1442A as the number of expected users and workload characteristics impacts performance. Yet another set of parameters that may be included in model 144 relates to share-all software instance 1443 such as unique Cognos® folders 1443A, software version upgrade 1443B, performance 1443C, and security 1443D. Yet another set of parameters that may be included in model 144 relates to service delivery model 1444 such as consumer and provider roles 1444A, service flows 1444B, and approvals 1444C.

Subsequently, once a basic model 144 is generated, each of the aforementioned parameters can be exposed by a different user or a human expert that may further enhance the model. By way of example, a Cognos® architect may be able to detail the parameters and consequences of putting multiple tenants on the same Cognos® Instance. An enterprise architect might enlist the enterprise mandates and questions (e.g. is SOX?). Similarly, An IT/Cognos® operations person might provide the mappings between Cognos® workloads and infrastructure configurations. A service process engineer might provide the service delivery organizational model and flow.

Then, and as explained above, the service designer/owner will decide what to do with the above parameters. He or she will use rules that map the information and decisions to one of the following: (1) fixed configurations; (2) inputs/selections to be made by the consumer upon service request; or (3) decisions to be made by the service delivery organization during the onboarding service flow—this can include for example the need to enhance the service architecture if the consumer is willing to pay or if there are enough consumers (e.g. enhancing the standard offering)

Finally, when the model is in place, on-boarding, administration and communication services can be automatically created to orchestrate and automate these services as explained above.

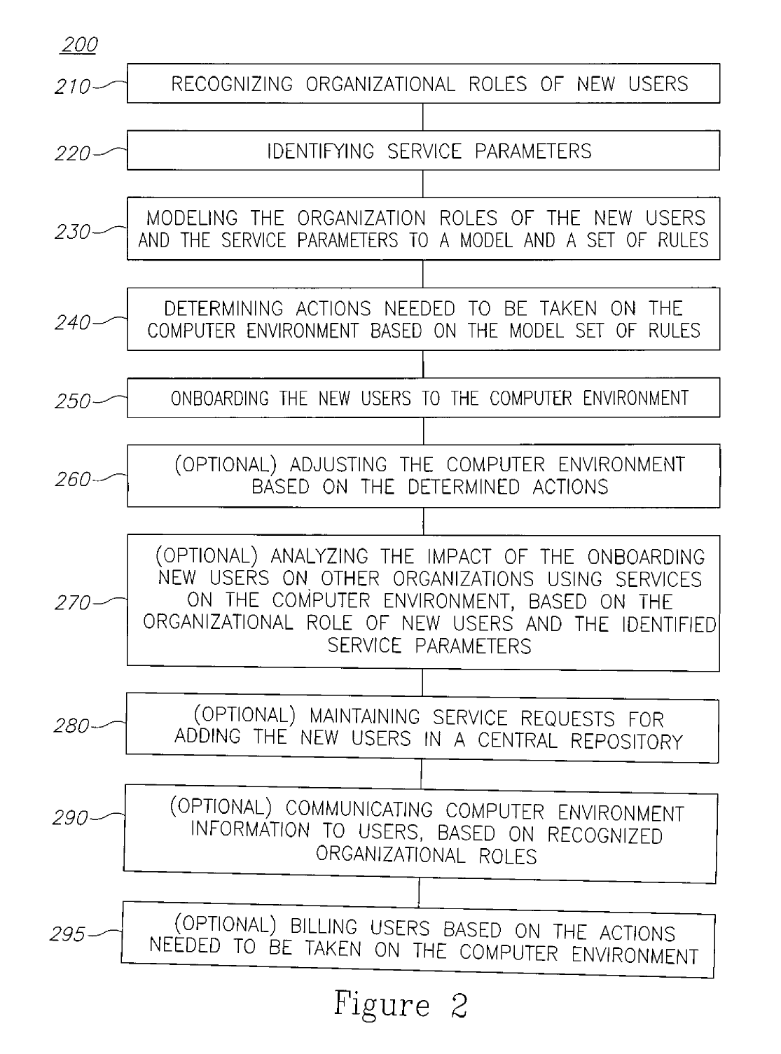

FIG. 2 is a high level flowchart diagram illustrating a method 200 of ascertaining requirements for onboarding new users in a computer environment having a plurality of services and a plurality of users from a plurality of organizations according to some embodiments of the invention. It is understood that method 200 may be carried out by software or hardware other than the aforementioned architecture of system 100. However, for the sake of simplicity, the discussion of the stages of method 200 is illustrated herein in conjunction with the components of system 100. Method 200 starts with recognizing 210 organizational roles of new users, possibly by role recognizer 120. Method 200 goes on to identifying 220 service parameters, possibly by service identifier 130. Method 200 goes on to mapping 230 the organization roles of the new users and the service parameters to a set of rules, possibly by modeler 140. Method 200 goes on to determining 240 actions needed to be taken on the computer environment based on the set of rules, possibly by actions determiner 150. Then, method 200 goes on to onboarding 250 the new users to the computer environment using on-boarding unit 110.

Optionally, method 200 may further include the stage of adjusting 260 the computer environment based on the determined actions. Method 200 may further include the stage of analyzing 270 an impact of the onboarding of the new users on other organizations using services on the computer environment, based on the organizational role of new users and the identified service parameters. Additionally, method 200 may further include the stage of maintaining service requests for adding the new users in a central repository. Optionally, method 200 may further include the stage of communicating 290 computer environment information to users, based on recognized organizational roles. Additionally, method 200 may further include the stage of billing 295 users based on the actions needed to be taken on the computer environment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “environment,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of ascertaining requirements for onboarding new users in a computer environment having a plurality of services and a plurality of users from a plurality of organizations, the method comprising:
recognizing organizational roles of new users;
identifying service parameters;
generating a model based on the organization roles of the new users and the service parameters, wherein the model is further associated with a set of rules;
determining actions needed to be taken on the computer environment based on the model and the set of rules; and
onboarding the new users to the computer environment in accordance with the model.

2. The method according to claim 1, further comprising adjusting the computer environment based on the determined actions.

3. The method according to claim 1, further comprising analyzing an impact of the onboarding of the new users on other organizations using services on the computer environment, based on the organizational role of new users and the identified service parameters.

4. The method according to claim 1, wherein at least some of the new users have different roles in different instances of the computer environment.

5. The method according to claim 1, further comprising maintaining service requests for adding the new users in a central repository.

6. The method according to claim 1, further comprising communicating computer environment information to users, based on recognized organizational roles.

7. The method according to claim 1, further comprising billing users based on the actions needed to be taken on the computer environment.

8. A system for ascertaining requirements for onboarding new users in a computer environment having a plurality of services and a plurality of users from a plurality of organizations, the system comprising:
a role recognizer configured to recognize organizational roles of new users;
a service identifier configured to identify service parameters;
a modeler configured to generate a model and a set of rules, based on the organization roles of the new users and the service parameters;
an actions determiner configured to determine actions needed to be taken on the computer environment based on the model and the set of rules; and
an onboarding unit configured to onboard the new users to the computer environment in accordance with the model.

9. The system according to claim 8, further comprising an adjustment unit configured to adjust the computer environment based on the determined actions.

10. The system according to claim 8, further comprising an analyzer configured to analyze the impact of the onboarding new users on other organizations using services on the computer environment, based on the organizational role of new users and the identified service parameters.

11. The system according to claim 8, wherein at least some of the new users have different roles in different instances of the computer environment.

12. The system according to claim 8, further comprising a service requests handler configured to maintain service requests for adding the new users in a central repository.

13. The system according to claim 8, further comprising a communication unit configured to communicate computer environment information to users, based on recognized organizational roles.

14. The system according to claim 8, further comprising a billing unit configured to bill users based on the actions needed to be taken on the computer environment.

15. A computer program product for ascertaining requirements for onboarding new users in a computer environment having a plurality of services and a plurality of users from a plurality of organizations, the computer program product comprising:
a computer readable storage medium having computer readable program embodied therewith, the computer readable program comprising:
computer readable program configured to recognize organizational roles of new users;
computer readable program configured to identify service parameters;
computer readable program configured to model the organization roles of the new users and the service parameters to a model and a set of rules;
computer readable program configured to determining actions needed to be taken on the computer environment based on the model and set of rules; and
computer readable program configured to onboard the new users to the computer environment in accordance with the model.

16. The computer program product according to claim 15, further comprising computer readable program configured to adjust the computer environment based on the determined actions.

17. The computer program product according to claim 15, further comprising computer readable program configured to analyze the impact of the onboarding new users on other organizations using services on the computer environment, based on the organizational role of new users and the identified service parameters.

18. The computer program product according to claim 15, wherein at least some of the new users have different roles in different instances of the computer environment.

19. The computer program product according to claim 15, further comprising computer readable program configured to maintain service requests for adding the new users in a central repository.

20. The computer program product according to claim 15, further comprising computer readable program configured to communicate computer environment information to users, based on recognized organizational roles.

21. The computer program product according to claim 15, further comprising computer readable program configured to bill users based on the actions needed to be taken on the computer environment.
